(19) United States
(12) Patent Application Publication
(10) Pub. No.: US 2021/0329848 A1
(43) Pub. Date: Oct. 28, 2021

(54) DYNAMICALLY ADJUSTABLE LIGHT-EMITTING DIODE (LED) PLANT LIGHT SUPPLEMENT SYSTEM AND A DYNAMIC LIGHT DIMMING METHOD

(71) Applicant: Nanjing Nigezi Agricultural Technology Co. LTD, Nanjing (CN)

(72) Inventors: Qing JI, Nanjing (CN); Xinhao YANG, Nanjing (CN); Min CHENG, Nanjing (CN)

(21) Appl. No.: 17/177,865

(22) Filed: Feb. 17, 2021

(30) Foreign Application Priority Data
Apr. 26, 2020 (CN) 202010338255.4

(51) Int. Cl. A01G 7/04

(52) U.S. Cl. CPC A01G 7/045

(57) ABSTRACT

A dynamically LED plant light supplement system includes RGBW light-filling lamp, the light-filling lamp driving unit, the lighting intensity collection unit, the plant growth monitoring unit, the centralized control unit, and the planting think tank. The plant growth monitoring unit, planting think tank, and lighting intensity collection unit are used to dynamically adjust the lighting intensity, light quality ratio, photoperiod and light time distribution of the plant lamp according to the plant type and growth stage. Lighting parameters, including the combination of light quality, the intensity of each single light quality, the operating cycle of each single light quality and the alternating cycle of different light quality, can be set according to the lighting formula so that the growth stage of the plant can be automatically determined without human intervention and the lighting formula can be dynamically switched.

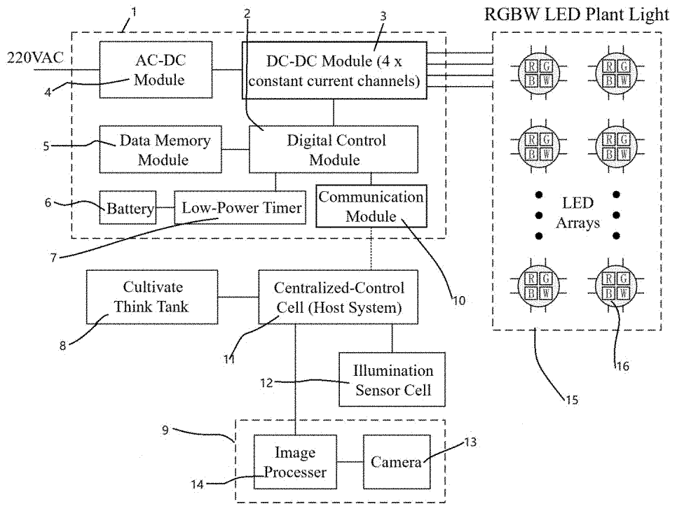

### FIELD OF THE INVENTION

The invention relates to the technical field of plant light systems, and more particularly, to A dynamically adjustable LED plant light supplement system and a dynamic dimming method.

### BACKGROUND OF THE INVENTION

The traditional planting methods are limited by the natural environment and planting technology. The yield and quality of crops are extremely limited and are prone to diseases and insect pests. With the rapid development of industrialization and urbanization, the available arable land area is decreasing, and there is a shortage of agricultural workforce. In order to improve crop products per unit area of cultivated land, reduce diseases and insect pests and lower the use of pesticides, technologies of modern agriculture such as three-dimensional planting and indoor planting using family courtyards have become the development priorities. The plant grow light system is an important unit in indoor planting such as smart greenhouses and plant factories. Light plays a key role in the completion of photomorphogenesis, plastid differentiation and plant growth and development. Illumination functions as the driving force of plant photosynthesis and the signal to control plant growth. It stimulates the related gene expressions to regulate plant growth and development, affecting plant yield and quality formation. There are a series of photoreceptors in plants, by which plants can accurately and timely sense changes in lighting environment. The plant grow light system can comprehensively and finely regulate the lighting intensity, light quality ratio, photoperiod and light temporal-spatial distribution of the lighting environment. A reasonable light control strategy can not only significantly improve the quality of plants, but also effectively reduce the energy consumption of light sources.

In terms of lighting intensity: the intensity of plant photosynthesis is closely related to the intensity of light. As the lighting intensity increases, the node with the same amount of CO₂ assimilation and CO₂ released by respiration is the light compensation point, and the node where photosynthesis no longer increases with the increase of lighting intensity is the light saturation point and different plants have different light compensation points and light saturation points. Fruits and vegetables require higher lighting intensity, while root vegetables and leaf vegetables require lower lighting intensity. Insufficient lighting intensity will lead to a decrease in photosynthesis intensity. In addition, it will change plant shape such as leaf size, thickness, mesophyll structure, internode length, stem thickness, etc., affecting plant growth and development, yield and quality. Coordinated control of lighting intensity can maximize the net photosynthesis of plants and the highest utilization rate of light energy.

In terms of light quality: When plants are photosynthesizing, the region with the strongest chlorophyll absorption spectrum is in the red light band with a wavelength of 600 to 700 nm and the blue band with a wavelength of 420 to 470 nm, that is, plant photosynthesis has the highest photon efficiency in the blue and red bands. In addition to affecting the rate of photosynthesis, different light qualities such as white light, red light, yellow light, blue light, and green light have different regulatory effects on plant growth and development, affecting plant chloroplast formation, photosynthetic pigment synthesis, leaf stomatal movement, leaf extension, carbon assimilation and rhizome growth. It can also affect the biosynthesis of soluble proteins and carbohydrates and regulate plant physiology and biochemistry and the synthesis of secondary metabolites such as carbohydrate metabolism, protein production, total phenols, anthocyanins, and ascorbic acid. For example, red light and far-red light play a very important role in photomorphogenesis. Blue light affects plant root development, stem elongation, phototropism and hormone balance. The ratio of red and blue light has an important influence on the content of plant nitrate, vitamin C, anthocyanin and soluble protein. Yellow-green light has a low photosynthetic utilization rate, but it can regulate the growth of the lower leaves of the plant, which can alleviate chlorophyll degradation, reduce nitrate content, and significantly increase the content of ascorbic acid, soluble sugar and soluble protein.

In terms of photoperiod: photoperiod is an important environmental factor affecting plant growth and development and material anabolic metabolism. Under natural conditions, the metabolic processes of plants show periodic changes with day and night. The activity of nitrate reductase in plants is affected by the photoperiod, which leads to the periodic changes of nitrate content in plants showing a decrease in light period and accumulation in dark period. Different photoperiods affect the biological rhythm clock through the plant's cryptochromes, regulate seed germination and seedling development, affect the production of photosynthetic products, carbohydrate accumulation and nutritional quality, and regulate plant flowering time.

In terms of the temporal-spatial distribution of light: the spatial distribution of light refers to the distribution of lighting intensity and color temperature in the light receiving surface area of the plant crown, upper and lower leaves, and the spatial irradiation angle of light relative to the light receiving surface of the plant. The uniformity of the spatial distribution of light is an important factor that affects the growth consistency of cultivated surface crops. The time distribution of light refers to the distribution of the combination of the same light quality and lighting intensity on the time axis of a photoperiod, which is mainly reflected in the mode differences of continuous light supply, alternate light supply and intermittent light supply. The following modes can be used in a 24 h day-night cycle: continuous light supply (16 h light, 8 h dark), 2 cycles of intermittent light supply (each 8 h light, 4 h dark), 4 cycles of intermittent light supply (4 h light each, 2 h dark). Different temporal distributions of light-supply time play an important role in regulating the plant type, dry matter, crude fiber, starch and soluble sugar content accumulation.

Plants have different requirements for the lighting environment at different growth stages. For example, red light irradiation is used to promote germination during seed germination, blue light is added during seedling stage to suppress excessive growth, green light is added to improve root vitality; in the cultivation stage, a specific proportion of red and blue qualities is used to promote plant growth and increase yield; in the flowering and fruiting stage, the photoperiod is used to adjust the flowering and fruiting time and shorten the cycle; continuous light is used to control the quality before harvesting. The optimal light conditions for different types of plants such as leaf vegetables, fruits, medicinal plants and flowers are different. The lighting formula can be set for varied plant type and growth stage, and the plant can grow in a relatively optimal state by dynamically adjusting the lighting environment.

As an artificial light source, LED has the advantages of low heat generation, precise and controllable lighting formula, diverse installation and adaptation modes, long service life, slow light attenuation and so on. It has been widely regarded as a suitable light source for plants to supplement light. At present, the light quality of the light source used in plant grow light is formed by the combination of monochromatic LED chips of red light with a wavelength of 660 nm and blue light with a wavelength of 460 nm, using several single-chip LEDs to form tubes or LED boards. Some newly developed LED light sources will also contain a small amount of ultraviolet and far red light. The LED fluorescent plant growth light converts part of the blue-violet light into red light or other light by coating the phosphor powder with the modulated components on the surface of the low-wavelength blue and violet LED chips.

Patent CN 206944051U discloses a spectrum-adjustable LED grow light with a number of red, yellow, white, and purple LED light beads combined into an LED array, which can adjust the spectrum.

Patent CN 202182363U discloses an LED lamp belt with adjustable lighting intensity by changing the number of red and blue light beads and switch control.

Patent CN 204670053U discloses a miniature plant factory that realizes adjustable spectrum through LED array and lenses of different colors.

Patent CN 209234363U discloses a planting greenhouse that realizes the selection of plant lamp spectrum module by adjusting the mechanical structure.

Patent CN 209250914U discloses an LED plant light system that detects the height of plants through infrared sensors and changes the spectrum by changing the number of red, green, and blue light emitters.

Patent CN 207349911U discloses a plant growth lamp which is placed with various LED lamp beads and whose brightness is adjusted by a knob.

Patent CN 2076351010 discloses an LED plant lamp that adjusts the ratio of red and blue light and the intensity of light through wireless communication.

Patent CN 110301253A discloses a method for adjusting the spectrum of plant lighting, using a single LED chip with phosphor technology, which can adjust the weight ratio of phosphor to meet the lighting requirements of plants in different physiological periods.

Patent CN 110285359A discloses an LED lamp for plant lighting whose lighting intensity is adjusted by the height of the support rod.

Patent CN 110249833A discloses a method of adding low-dose long-wave ultraviolet light on the basis of conventional LED light sources to improve the yield and quality of leaf vegetables in plant factories.

Patent CN 109964683A discloses a method of adding low-dose far-red light to the photoperiod to improve the light energy utilization efficiency of leaf vegetables in plant factories, causing leaf vegetables to exhibit stem and petiole elongation, elevated leaf angle, and increased leaf area and other characteristics of shade plants.

Patent CN 109751537A discloses a plant growth lamp in which LED lamp beads are arranged in a staggered interval to solve the technical problem that the wavelength in the area is not uniform.

Patent CN 104359049A discloses a method and equipment for adjusting the intensity of an artificial light source, the distance from a plant canopy, and a focusing lens to provide a plant with an accurate illumination range and intensity.

Patent CN 105828479A discloses a continuously adjustable driving power supply that realizes the light quality ratio R/B of different LED lamp light sources by adjusting a sliding rheostat.

The LED plant lamps of the existing plant grow light apparatus use different-colored lamp beads to form an LED array, which is mixed into a specific spectrum after luminescence, or use phosphor to adjust the spectrum. After completing the installation of the apparatus, the ratio of different color lamp beads is fixed. When the same color LED driving power is used to drive the light emitting arrays of different colors, the light quality ratio of the LED array after light mixing is not adjustable. Some existing technologies adjust the spectrum by changing the mechanical structure or changing the ratio of the lamp beads, but replacement of the plant grow light apparatus or frequent manual intervention are needed;

After using different colors of lamp beads to form an LED array or mixing different phosphors to mix light, the spectrum is limited by the number of lamp beads, and the spectrum can only be applied to a specific plant or a specific type of specific growth stage in a general sense. In fact, different plants have different requirements for the light quality ratio, and even for the same type of plants, the optimal lighting conditions at the stage of germination, plant growth, flowering, and fruiting are different;

The existing plant grow light devices do not contain monitoring units to analyze the growth stage of the plant, or can only judge the height of the plant through a simple sensor, and cannot automatically adjust the lighting conditions according to the growth stage of the plant.

### SUMMARY OF THE INVENTION

With the foregoing shortcomings of the prior art in mind, the object of the invention is to provide a dynamically adjustable LED plant light supplement system and a dynamic dimming method.

The technical solution adopted by the invention to solve its technical problem is: a dynamically LED plant light supplement system, including: RGBW light-filling lamp, light-filling lamp driving unit, lighting intensity collection unit, plant growth monitoring unit, centralized control unit, planting think tanks;

RGBW light-filling lamp is used to emit and can independently control red, green, blue and white light source LED lamp beads;

Light-filling lamp driving unit is used to individually control the red, green, blue and white light emitting units in RGBW light-filling lamp;

The lighting intensity collection unit is used to collect the lighting intensity information received by the plants and feed it back to the centralized control unit;

Plant growth monitoring unit is used to detect the real-time growth status of plants and pass relevant parameters to the centralized control unit;

Planting think tanks is used to store the optimal lighting parameters and formulas for different plants at different growth stages, including lighting intensity, light quality ratio, photoperiod and lighting time distribution;

The centralized control unit is used to feed back the current lighting intensity data to the light-filling lamp driving unit, and the drive current is corrected according to the lighting formula data parameters to ensure the accuracy of the photoperiod and lighting intensity; it is convenient for manual correction and direct adjustment by the person through the centralized control unit lighting intensity, light quality ratio, photoperiod and lighting time distribution, or supplement, modify or delete the light solution and formula data in the planting think tank through a centralized control unit.

In the foregoing design, the plant growth monitoring unit, planting think tank, and lighting intensity collection unit can be used to dynamically adjust the lighting intensity, light quality ratio, photoperiod and lighting time distribution of the plant lamp according to the plant type and growth stage. Illumination parameters, including the combination of light quality, the intensity of each single light quality, the operating cycle of each single light quality and the alternating cycle of different light quality, can be set according to the lighting formula so that the growth stage of the plant can be automatically determined without human intervention and the lighting formula can be dynamically switched to provide any controllable light conditions at each growth stage, to promote plant growth in different plants, to regulate plant quality and to achieve efficient cultivation.

As the further improvement of this design, the RGBW light-filling lamp is an LED array of lamp beads combined with RGBW four-color light-emitting units. Each lamp bead in the LED array integrates four light-emitting units of red light, green light, blue light, and white light. Each lamp bead has 8 lead terminals, which are the positive and negative terminals of red light, the positive and negative terminals of green light, the positive and negative terminals of blue light, and the positive and negative terminals of white light. The luminous brightness of each color light-emitting unit can be individually controlled, thereby controlling the overall lighting intensity and light quality ratio.

As the further improvement of the present design, the light-emitting units of the same color in the LED array are connected in series to the four drive input terminals of the RGBW light-filling lamp. It is convenient to control each light-emitting unit individually.

As the further improvement of this design, the light-filling lamp driving unit includes an AC-DC conversion module, a DC-DC conversion module electrically connected to the output end of the AC-DC conversion module, a digital control module connected to the DC-DC conversion module, a data storage module communicatively connected to the digital control module, a timing module in communication with the digital control module, a communication module communicatively connected to the digital control module and the centralized control unit;

The AC-DC conversion module is used to convert 220V AC to 12V˜48V DC;

DC-DC conversion module is used to convert 12V˜48V DC to four-channel DC drive for RGBW light-filling lamp;

The data storage module is used to store the lighting formula data needed to dynamically adjust the light conditions;

The timing module is used to calculate the current time information on year, month, day, hour, minute, and second through battery power in an uninterrupted manner;

The communication module is used to exchange information with the centralized control unit, send the current lighting information to the centralized control unit, or receive instructions from the centralized control unit to adjust the lighting formula;

The digital control module is used to read, modify or send data to the data storage module, timing module and communication module. According to the light solution, it provides digital control signals to the DC-DC conversion module. The DC-DC conversion module with multiple independent control outputs is used to drive the current and duration of the LED branches of different light quality of the plant lamp in a constant current and no flicker mode. The data storage module is used to store the lighting formula parameters. The timing module is used to calculate the time, which can dynamically adjust the lighting intensity, light quality ratio, photoperiod and lighting time distribution for different plants and different growth stages, so as to achieve efficient plant cultivation.

As a further improvement of the design, the lighting intensity collection unit is composed of light sensors that read the lighting intensity data, and the sensors are driven by the centralized control unit, with the lighting intensity monitoring being more accurate.

As a further improvement of the design, the plant growth monitoring unit includes a camera and an integrated image processor communicatively connected to the camera. The integrated image processor is used to calculate the plant height based on the data collected by the camera and analyze the growth status of plants, including but not limited to the status of germination, plant growth, flowering and fruiting, and then the status data are sent to the centralized control unit. In this way, the accurate monitoring of plant growth status is realized.

As a further improvement of this design, the centralized control unit is a host computer.

A dynamic dimming method for a dynamically adjustable LED plant grow light system comprises the following steps:

S1: The user selects or inputs the plant name or type in the centralized control unit;

S2: The centralized control unit reads the optimal lighting solution of the plant from the planting think tank according to S1, reads the growth status from the plant growth monitoring unit, reads the growth state parameters from the plant growth monitoring unit, sets the lighting formula and sends it to the light-filling lamp driving unit. The lighting formula parameters are stored in the memory of the light-filling lamp driving unit;

S3: The digital control module in the light-filling lamp driving unit reads the lighting formula parameters from the memory, reads the current time from the low-power timing module, and compares the lighting formula parameters to calculate the size and driving time of the current required for driving the red, green, blue, and white light. It drives RGBW light-filling lamp in a constant current mode to produce the lighting intensity, spectrum, photoperiod and lighting time distribution required by the plant at the current time;

S4: The centralized control unit reads the data of the lighting intensity collection unit, feeds back the current lighting intensity data to the light-filling lamp driving unit, and corrects the drive current according to the lighting formula data parameters to ensure the accuracy of the photoperiod and lighting intensity;

It is easy to adjust and facilitate the dynamic adjustment of plant lighting.

As a further improvement of this design, after the user selects the plant, the dynamic adjustment of the lighting environment does not require manual intervention, thus high degree of automation is achieved.

As a further improvement of this design, the user directly adjust the lighting intensity, light quality ratio, photoperiod and lighting time distribution through the centralized control unit, or supplement, modify or delete lighting solutions and formula data in the planting think tank through the centralized control unit, thus wider applicability is realized.

The beneficial effects of the invention are as follows: the invention uses a plant growth monitoring unit, a planting think tank, and a lighting intensity collection unit to dynamically adjust the lighting intensity, light quality ratio, photoperiod and lighting time distribution of the plant lamp according to the plant type and growth stage. Illumination parameters, including the combination of light quality, the intensity of each single light quality, the operating cycle of each single light quality and the alternating cycle of different light quality, can be set according to the lighting formula so that the growth stage of the plant can be automatically determined without human intervention and the lighting formula can be dynamically switched to provide any controllable light conditions at each growth stage, to promote plant growth in different plants, to regulate plant quality and to achieve efficient cultivation.

### BRIEF DESCRIPTION OF THE DRAWINGS

The invention is further described below with reference to the drawings and embodiments.

The FIGURE shows a schematic diagram of the LED plant grow light system of the present disclosure.

In the FIGURE, 1. light-filling lamp driving unit, 2. digital control module, 3. DC-DC conversion module, 4. AC-DC conversion module, 5. Data storage module, 6. Battery, 7. Timing module, 8. Planting think tank, 9. Plant growth monitoring unit, 10. Communication module, 11. Centralized control unit, 12. lighting intensity collection unit, 13. Camera, 14. Integrated image processor, 15. RGBW light-filling lamp, 16. Lamp beads.

### DETAILED DESCRIPTION OF EMBODIMENTS

Hereinafter, reference will now be made in detail to various embodiments of the invention, examples of which are described below. While the invention will be described in conjunction with exemplary embodiments, it will be understood that the present description is not intended to limit the invention to those exemplary embodiments.

Embodiment: in the FIGURE, a dynamically adjustable LED plant grow light system, including: RGBW light-filling lamp 15, light-filling lamp driving unit 1, lighting intensity collection unit 12, plant growth monitoring unit 9, centralized control unit 11, planting think tank 8;

RGBW light-filling lamp 15 is used to emit and can independently control four light sources of red light, green light, blue light and white light;

Light-filling lamp driving unit 1 is used to individually control the red, green, blue and white light-emitting units of RGBW light-filling lamp 15;

The lighting intensity collection unit 12 is used to collect the lighting intensity information received by the plants and feed it back to the centralized control unit 11;

The plant growth monitoring unit 9 is used to detect the real-time growth state of the plant and transmit relevant parameters to the centralized control unit 11;

Planting Think Tank 8 is used to store the optimal lighting parameters and formulas for different plants in different growth stages, including lighting intensity, light quality ratio, photoperiod and lighting time distribution;

The centralized control unit 11 is used to feed back the current lighting intensity data to light compensating lamp driving unit 1, and the drive current is corrected according to the lighting formula data parameters to ensure the accuracy of the photoperiod and the lighting intensity; it is convenient for manual correction and for people to directly pass the centralized control unit 11 Directly adjust the lighting intensity, light quality ratio, photoperiod and lighting time distribution, or supplement, modify or delete the light solution and formula data in the planting think tank 8 through the centralized control unit 11.

In the above design, the plant growth monitoring unit 9, planting think tank 8, lighting intensity collection unit 12 can dynamically adjust the lighting intensity, light quality ratio, photoperiod and lighting time distribution of the plant lamp according to the plant type and growth stage. The formula sets the lighting parameters, including the combination of light quality, the lighting intensity of each single light quality, the operating cycle of each single light quality and the alternating cycle of different light quality, and automatically judges the growth of the plant without the need for manual intervention. The lighting formula is dynamically switched to provide any controllable light conditions in each growth stage and to promote plant growth in different plants, regulate plant quality, and achieve efficient cultivation.

As a further improvement of this design, the RGBW light-filling lamp 15 is an integrated LED array of LED beads 16 integrated with RGBW four-color light-emitting units, and each LED 16 in the LED array integrates four red, green, blue and white light. In this kind of light-emitting unit, each lamp bead 16 has 8 lead terminals, which are the positive and negative terminals of red light, the positive and negative terminals of green light, the positive and negative terminals of blue light, and the positive and negative terminals of white light. The luminous brightness of each color light-emitting unit can be individually controlled, thereby controlling the overall lighting intensity and light quality ratio.

As a further improvement of this design, the light-emitting units of the same color in the LED array are connected in series to the four drive input terminals of the RGBW 15 which are the positive and negative terminals of red light, the positive and negative terminals of green light, the positive and negative terminals of blue light, and the positive and negative terminals of white light. The luminous brightness of each color light-emitting unit can be individually controlled, thereby controlling the overall lighting intensity and light quality ratio respectively. It is convenient to control each light-emitting unit individually.

As a further improvement of the present design, the light-filling lamp driving unit 1 includes an AC-DC conversion module 4, a DC-DC conversion module 3 electrically connected to the output end of the AC-DC conversion module 4, and the DC-DC conversion module. The conversion module 3 controls the connected digital control module 2, the data storage module 5 communicatively connected to the digital control module 2, the timing module 7 communicatively connected to the digital control module 2, and the communication module 10 that is communicatively connected to the digital control module 2 and the centralized control unit 11;

The AC-DC conversion module 4 is used to convert 220V AC to 12V˜48V DC; The DC-DC conversion module 3 is used to convert 12V˜48V DC power into four-way DC drive of RGBW LED light compensating lamp;

The data storage module 5 is used to store the lighting formula data needed to dynamically adjust the lighting conditions;

The timing module 7, powered by battery 6 for uninterrupted calculation of time information on current year, month, day, hour, minute, and second;

The communication module 10 is used to exchange information with the centralized control unit 11, send the current lighting information to the centralized control unit 11, or receive an instruction from the centralized control unit 11 to adjust the lighting formula;

The digital control module 2 is used to read, modify or send data to the data storage module 5, the timing module 7 and the communication module 10, and provides a digital control signal to the DC-DC conversion module 3 according to the lighting solution. The DC-DC conversion module 3 with multiple independent control outputs is used to drive the current and duration of the LED branches of different light quality of the plant lamp in a constant current and no flicker mode. The data storage module 5 is used to store the lighting formula The parameters, using the timing module 7 to calculate the time, can dynamically adjust the lighting intensity, light quality ratio, photoperiod and lighting time distribution for different plants and different growth stages to achieve efficient plant cultivation.

As a further improvement of the present design, the lighting intensity collection unit 12 is composed of a light sensor that is driven by the centralized control unit 11 and reads lighting intensity data. lighting intensity monitoring is more accurate.

As a further improvement of this design, the plant growth monitoring unit 9 includes a camera 13 and an integrated image processor 14 communicatively connected to the camera 13, the integrated image processor 14 is used to calculate the plant height based on the data collected by the camera 13 To determine the plant growth status, including but not limited to germination, plant growth, flowering and fruiting status, and then send the status data to the centralized control unit 11. Facilitates accurate monitoring of plant growth status.

As a further improvement of this design, the centralized control unit 11 is a host computer.

A dynamically adjustable LED plant light supplement system includes the following steps:

S1: A human user selects or inputs the plant name or type in the centralized control unit 11;

S2: The centralized control unit 11 reads the optimal light solution of the plant from the planting think tank 8 according to step S1, reads the growth state parameters from the plant growth monitoring unit 9, sets the lighting formula and sends it to light-filling lamp driving unit 1. The lighting formula parameters are stored in the memory of light-filling lamp driving unit 1;

S3: The digital control module 2 in the light-filling lamp driving unit 1 reads the lighting formula parameters from the memory, reads the current time from the low-power timing module 7, and compares the lighting formula parameters to calculate the size and driving time of the current required for driving the red, green, blue, and white light. It drives RGBW light-filling lamp 15 in a constant current mode to produce the lighting intensity, spectrum, photoperiod and lighting time distribution required by the plant at the current time;

S4: 4: The centralized control unit 11 reads the data of the lighting intensity collection unit 12, feeds back the current lighting intensity data to the light-filling lamp driving unit 1, and corrects the drive current according to the lighting formula data parameters to ensure the accuracy of the photoperiod and lighting intensity;

It is easy to adjust and facilitate the dynamic adjustment of plant light.

As a further improvement of this design, after the user selects the plant, the dynamic adjustment of the lighting environment does not require manual intervention. High degree of automation is realized.

As a further improvement of this design, the user directly adjust the lighting intensity, light quality ratio, photoperiod and lighting time distribution through the centralized control unit 11, or supplement, modify or delete lighting solutions and formula data in the planting think tank 8 through the centralized control unit 11, thus wider applicability is realized.

The above is only embodiments of the invention; not thereby limit the scope of the claims of the invention; every equivalent structure or equivalent flow process conversion that utilizes instructions of the invention and accompanying drawing content to do; or directly or indirectly be used in other relevant technical fields, all in like manner be included in scope of patent protection of the invention.

1. A dynamically adjustable LED plant light supplement system, comprising: a RGBW light-filling lamp, a light-filling lamp driving unit, a lighting intensity collection unit, a plant growth monitoring unit, a centralized control unit, and a planting think tank;
wherein the RGBW light-filling lamp is used to emit and can independently control red, green, blue and white light source LED lamp beads;
wherein the light-filling lamp driving unit is used to individually control the red, green, blue and white light emitting units in RGBW light compensating lamp;
wherein the lighting intensity collection unit is used to collect the lighting intensity information received by the plants and feed it back to the centralized control unit;
wherein there plant growth monitoring unit is used to detect the real-time growth status of plants and pass relevant parameters to the centralized control unit;
wherein the planting think tank is used to store the optimal lighting parameters and formulas for different plants at different growth stages, including lighting intensity, lighting quality ratio, photoperiod and light time distribution;
wherein the centralized control unit is used to feed back the current lighting intensity data to the light-filling lamp driving unit, and the drive current is corrected according to the lighting formula data parameters to ensure the accuracy of the photoperiod and lighting intensity; it is convenient for manual correction and direct adjustment of lighting intensity, light quality ratio, photoperiod and lighting time distribution by the person through the centralized control unit, and it is convenient to supplement, modify or delete the lighting solution and formula data in the planting think tank through a centralized control unit.

2. The system according to claim 1, wherein that the RGBW light-filling lamp is an LED array of lamp beads combined with RGBW four-color light-emitting units. Each lamp bead in the LED array integrates four light-emitting units of red light, green light, blue light, and white light. Each lamp bead has 8 lead terminals, which are the positive and negative terminals of red light, the positive and negative terminals of green light, the positive and negative terminals of blue light, and the positive and negative terminals of white light.

3. The system according to claim 2, wherein the light-emitting units of the same color in the LED array are connected in series to the four input ends of the drivers of the RGBW light-filling lamp.

4. The system according to claim 1, wherein the light-filling lamp driving unit includes an AC-DC conversion module, a DC-DC conversion module electrically connected to the output end of the AC-DC conversion module, a digital control module connected to the DC-DC conversion module, a data storage module communicatively connected to the digital control module, a timing module in communication with the digital control module, a communication module communicatively connected to the digital control module and the centralized control unit; the AC-DC conversion module is used to convert 220V AC mains to 12V˜48V DC;
wherein the DC-DC conversion module is used to convert 12V˜48V DC to four-channel DC drive for RGBW LED RGBW light-filling lamp;
wherein the data storage module is used to store the lighting formula data needed to dynamically adjust the light conditions;
wherein the timing module is used to calculate the current time information on year, month, day, hour, minute, and second through battery power in an uninterrupted manner;
wherein the communication module is used to exchange information with the centralized control unit, send the current light information to the centralized control unit, or receive instructions from the centralized control unit to adjust the lighting formula;
wherein the digital control module is used to read, modify or send data to the data storage module, timing module and communication module. According to the light solution, it provides digital control signals to the DC-DC conversion module.

5. The system according to claim 1, wherein the lighting intensity collection unit is composed of light sensors that read the lighting intensity data, and the sensors are driven by the centralized control unit.

6. The system according to claim 1, wherein the plant growth monitoring unit comprises a camera, an integrated image processor communicatively connected to the camera, the integrated image The processor is used to calculate the plant height based on the data collected by the camera, determine the plant growth status, including but not limited to the status of germination, plant growth, flowering and fruiting, and then send the status data to the centralized control unit.

7. The system according to claim 1, wherein the centralized control unit is a host computer.

8. A dynamic dimming method for A dynamically adjustable LED plant light supplement system, comprising the following steps:
S1: selecting or inputting the plant name or type in the centralized control unit;
S2: via the centralized control unit reading the optimal light solution of the plant from the planting think tank according to S1, reading the growth state parameters from the plant growth monitoring unit, setting the lighting formula and sends it to the light compensating lamp driving unit, wherein the lighting formula parameters are stored in the memory of the light-filling lamp driving unit;
S3: via the digital control module in the light-filling lamp driving unit reading the lighting formula parameters from the memory, reading the current time from the low-power timing module, and comparing the lighting formula parameters to calculate the size and driving time of the current required for driving the red, green, blue, and white light, wherein a RGBW light-filling lamp is driven in a constant current mode to produce the lighting intensity, spectrum, photoperiod and lighting time distribution required by the plant at the current time;
S4: via the centralized control unit reading the data of the lighting intensity collection unit, feeding back the current lighting intensity data to the light-filling lamp driving unit, and correcting the drive current according to the lighting formula data parameters to ensure the accuracy of the photoperiod and lighting intensity.

9. The method according to claim 8, wherein the dynamic adjustment of the light environment does not require manual intervention after the user selects the plant.

10. The method according to claim 8, wherein the user directly adjust the lighting intensity, light quality ratio, photoperiod and lighting time distribution through the centralized control unit, or supplement, modify or delete light solutions and formula data in the planting think tank through the centralized control unit.
